(19) United States
(12) Patent Application Publication
(10) Pub. No.: US 2025/0072457 A1
(43) Pub. Date: Mar. 6, 2025

(54) Beverages Comprising Protein Sweeteners with Improved Taste and Mouthfeel

(71) Applicant: The Coca-Cola Company, Atlanta, GA (US)

(72) Inventors: Indra Prakash, Alpharetta, GA (US); Zhu Gao, Marietta, GA (US); Rohan Dodal, Atlanta, GA (US); Christopher Mercogliano, Atlanta, GA (US)

(21) Appl. No.: 18/724,958

(22) PCT Filed: Dec. 30, 2022
(86) PCT No.: PCT/US2022/082614

§ 371 Date: Jun. 27, 2024

Related U.S. Application Data
(60) Provisional application No. 63/295,080, filed on Dec. 30, 2021.

(51) Int. Cl. A23L 2/60; A23L 2/06; A23L 2/40; A23L 2/66; A23L 27/00; A23L 27/30; A23L 33/125; A23L 33/20

(52) U.S. Cl. CPC A23L 2/60; A23L 2/06; A23L 2/40; A23L 2/66; A23L 27/33; A23L 27/88; A23L 33/125; A23L 33/20

(57) ABSTRACT

Diet beverages comprising at least one protein sweetener are provided herein. The protein sweeteners act to enhance the mouthfeel of certain beverages and/or modulate one or more taste attributes of the beverage to provide a beverage with more sucrose-sweetened taste characteristics. Methods of preparing beverages and methods of enhancing the mouthfeel and/or one or more taste attributes of beverages are also detailed herein.

### CROSS REFERENCE TO RELATED APPLICATION

The present application claims priority to U.S. Provisional Patent Application No. 63/295,080, filed Dec. 30, 2021, the contents of which is hereby incorporated by reference

### FIELD OF THE INVENTION

The present invention relates generally to diet beverages containing at least one protein sweetener. The present invention further extends to methods of enhancing the mouthfeel and taste quality of a diet beverage, methods of making a diet beverage taste more like a sugar-sweetened beverage, and methods of preparing beverages.

### BACKGROUND OF THE INVENTION

Natural caloric sugars, such as sucrose, fructose, and glucose, are used to provide a pleasant taste to beverages and foods. Sucrose imparts a taste preferred by consumers. Although sucrose provides superior sweetness characteristics, it is disadvantageously caloric.

Consumers increasingly prefer non-caloric or low caloric beverages (e.g. “diet”, “reduced calories”, “light beverages”, “calorie-reduced beverage,” etc.). However, these diet versions of beverages often have a lower consumer acceptance rate as they lack the mouthfeel, body and flavor of their regular full calorie beverage counterparts. High intensity sweeteners can partially or totally substitute for high calorie ingredients in such beverages, but the challenge of maintaining the flavor, the mouthfeel, and the body of the regular beverage remains.

Accordingly, there is a need for improved diet beverage formulations that have reduced quantities of caloric sweeteners (e.g., carbohydrate sweeteners) that deliver satisfying mouthfeel and more sucrose-like taste characteristics.

### SUMMARY OF THE INVENTION

In one aspect, the present invention provides a diet beverage comprising at least one protein sweetener. The at least one protein sweetener modulates one or more taste attributes of the diet beverage to make the beverage taste more like a sucrose-sweetened beverage and/or to enhance the mouthfeel of the diet beverage.

The protein sweetener can be a naturally occurring protein sweetener or a modified protein sweetener.

The protein sweetener is present in the beverage in a concentration from about 2 ppm to about 20 ppm.

In certain embodiments, the diet beverage further comprises at least one additional, non-protein sweetener. In certain embodiments, the sweetener is a high potency sweetener. Particularly desirable high potency sweeteners include steviol glycosides (e.g., rebaudiosides A, B, D, M and N) and steviol glycoside mixtures, mogrosides (e.g., mogroside V, siamenoside I, mogroside IV, and mogroside IIIe) and mogroside mixtures. In other embodiments, the sweetener is a carbohydrate sweetener, a synthetic sweetener, a sugar alcohol sweetener, or a rare sugar. In certain embodiments, the diet beverage comprises sucrose. Combinations of one or more additional sweeteners are also contemplated herein.

In another aspect, the present invention provides a method of enhancing the mouthfeel of a diet beverage comprising (i) providing a diet beverage and (ii) adding at least one protein sweetener described herein to the diet beverage in an amount effective to enhance the mouthfeel of the diet beverage compared to the diet beverage in the absence of the at least one protein sweetener.

In another aspect, the present invention provides a method of making a diet beverage taste more like a sucrose-sweetened beverage comprising (i) providing a diet beverage and (ii) adding at least one protein sweetener described herein in an amount effective to modulate one or more taste attributes of the diet beverage to make the diet beverage taste more like a sucrose-sweetened beverage compared to the diet beverage in the absence of the at least one protein sweetener.

In another aspect, the present invention provides a method of preparing a beverage comprising (i) providing a diet beverage and (ii) adding at least one protein sweetener to the diet beverage.

### DETAILED DESCRIPTION OF THE INVENTION

### I. Definitions

“Amino acid sequence” is used to describe a protein having an amino acid sequence. As such, the term “reference protein” is equivalent to the term “reference amino acid sequence” and the term “modified protein” is equivalent to the term “modified amino acid sequence”.

“Beverage”, as used herein, refers to liquids suitable for human consumption.

“Diet beverage,” as used herein, refers to reduced-calorie beverages including mid-calorie beverages, low-calorie beverages, and zero-calorie beverages. Some diet beverages may contain sucrose, but in a quantity less than a full-calorie beverage. Diet beverages herein comprise at least one non-sucrose sweetener, e.g., a high potency sweetener.

“Full-calorie beverage,” as used herein, refers to a beverage that has from 61 calories to about 120 calories per 8 oz serving. Full-calorie beverages are typically sweetened with caloric sweeteners, e.g., sucrose or fructose.

“Mid-calorie beverage,” as used herein, refers to a beverage that has from 41 to 60 calories per 8 oz. serving.

“Low-calorie beverage,” as used herein, refers to a beverage that has from 6 to 40 calories per 8 oz. serving.

“Zero-calorie beverage,” as used herein, refers to a beverage that has less than 5 calories per 8 oz. serving.

“Beverage matrix,” as used herein, refers to a beverage containing all typical ingredients except the sweetener(s) or sweetener composition.

“Beverage product”, as used herein, refers to a ready-to-drink beverage, a beverage concentrate, a beverage syrup, or a powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry, and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

Alcoholic beverages are also contemplated herein, both carbonated and non-carbonated alcoholic beverages. Alcohols that can be used in the present invention are not particularly limited, and may be any alcohol that is drinkable. Examples include brewed alcohols, spirits (e.g., gin, vodka, rum, tequila), liquors, whiskeys (e.g., whiskey, brandy), shochu, and brews (e.g., sake, wine, and beer).

“pH stability”, as used herein, refers to a stability of the modified protein sweetener at a wider pH range relative to the reference protein sweetener.

“Functional thermal stability”, as used herein, refers to the ability of the modified protein sweetener to retain its function after exposure to high temperatures compared with the reference protein sweetener.

“Natural high potency sweetener” or “NHPS” as used herein, refers to any sweetener found naturally in nature and characteristically has a sweetness potency greater than sucrose, fructose, or glucose, yet has less calories. The natural high potency sweetener can be provided as a pure compound or, alternatively, as part of an extract.

“Sequence similarity” or “sequence homology”, as used herein, refers to the amount (%) of amino acids that are conserved with similar physicochemical properties, e.g. leucine and isoleucine. In certain embodiments, “sequence similarity” refers to the amount (%) of amino acids that are conserved between a modified protein sweetener and a reference protein sweetener.

“Synthetic sweetener,” as used herein, refers to any composition which is not found naturally in nature and characteristically has a sweetness potency greater than sucrose, fructose, or glucose, yet has less calories.

“Sweetening amount”, as used herein, refers to the concentration of a substance sufficient to perceptibly sweeten the beverage.

“Sweetness recognition threshold”, as used herein, refers to the lowest known concentration of a compound that is perceivable by the human sense of taste as sweet. The sweetness recognition threshold concentration is specific for a particular compound, and can vary based on temperature, matrix, ingredients and/or flavor system. A 1.5% (w/v) sucrose solution is generally considered the minimum perceivable sweet taste to humans. Accordingly, it is routine for compounds evaluated for their isosweetness with a 1.5% (w/v) sucrose solution. The concentration at which the compound is isosweet with a 1.5% (w/v) sucrose solution is considered the compounds' sweetness recognition threshold concentration.

“Structural thermal stability” or “thermal stability”, as used herein, refers to the ability of the modified protein sweetener to retain its 3D structure at temperatures above that of the reference protein sweetener. The 3D structural stability of a protein can be measured by any method known in the art, such as Circular Dichroism (CD), or thermal shift assays such as Differential Scanning Fluorimetry (DSF) or Differential Scanning calorimetry (DSC). The 3D structure of a protein may have an effect on the function of the protein. Notably, the shelf-life and thermal stability required for food and beverage products may be related to the structural thermal stability and consists of different measurables e.g., pasteurization can be applied by different protocols and is related to the heat resistance of retaining the protein structure over a very short time.

“Taste modulator”, as used herein, refers to a compound that positively impacts the perception of a non-sucrose sweetener in a consumable (e.g., a beverage) in such a way that the consumable tastes more like a sucrose-sweetened beverage. For example, certain negative taste properties of non-sucrose sweeteners can be masked with taste modulators, e.g., bitterness, sourness, astringency, saltiness, and metallic notes. In another example, mouthfeel is improved. In still another example, sweetness linger is decreased. In yet another example, sweetness onset is increased. In a still further example, the bitterness linger is improved.

“Total mogroside content”, as used herein, refers to the sum of the relative weight contributions of each mogroside in a sample.

“Total steviol glycoside content”, as used herein, refers to the sum of the relative weight contributions of each steviol glycoside in a sample.

### II. Beverages

The present invention provides diet beverages comprising at least at least one protein sweetener. The at least one protein sweetener modulates one or more taste attributes of the beverage to make the diet beverage taste more like a sucrose-sweetened beverage. Exemplary taste attribute modulations include decreasing or eliminating bitterness, decreasing or eliminating bitter linger, decreasing or eliminating sourness, decreasing or eliminating astringency, decreasing or eliminating saltiness, decreasing or eliminating metallic notes, decreasing or eliminating licorice notes, improving mouthfeel, decreasing or eliminating sweetness linger, increasing sweetness onset and increasing sweetness intensity. In a particular embodiment, the at least one protein sweetener improves or enhances mouthfeel. Multiple taste attributes can be modulated simultaneously, such that the protein sweetener-containing beverage, overall, has more sucrose-sweetened characteristics. Methods of quantifying improvement in sucrose-sweetened characteristics are known in the art and include taste testing and histogram mapping with controls in the absence of the at least one protein sweetener.

In one embodiment, the at least one protein sweetener enhances the mouthfeel of the diet beverage and/or modulates one or more taste attributes of the beverage to make the beverage taste more like a sucrose-sweetened beverage.
A. Protein Sweeteners

Beverages of the present invention comprise at least one protein sweetener.

In certain embodiments, the at least one protein sweetener is selected from the group consisting of thaumatin, monellin, mabinlin, pentadin, brazzein, curculin (or neoculin), miraculin, egg lysozyme, sweet truffle protein, and combinations thereof. In certain embodiments, the protein sweetener is a naturally occurring protein. In certain embodiments, the protein sweetener is derived from plants, for example capparis masaikai, oubli, serendipity berry, katemfe, miracle fruit berry, or lemba. In certain embodiments, the protein sweetener is derived from Thaumatococcus danielli Benth, Dioscoreophyllum cumminsii Diels, Capparis masakai Levi, Pentadiplandra brazzeana Baillon, Curculingo latifolia or Richadella dulcifica.

In some embodiments, the protein sweetener is thaumatin. I

In some embodiments, the protein sweetener is thaumatin-1 (GenBank Entry No. P02883; SEQ ID NO:1). In some embodiments, the protein sweetener is thaumatin-2 (GenBank Entry No. P02884; SEQ ID NO:2).

In some embodiments, the protein sweetener is monellin comprising chain A (GenBank Entry No. P02881; SEQ ID NO:3) and chain B (GenBank Entry No. P02882; SEQ ID NO:4).

In some embodiments, the protein sweetener is miraculin (GenBank Entry No. PI 3087; SEQ ID NO:6).

In some embodiments, the protein sweetener is curculin-1 GenBank Entry No. P19667; SEQ ID NO:7) or curculin-2 (GenBank Entry No. Q6F495; SEQ ID NO:8).

In some embodiments, the protein sweetener is brazzein (also known as: Defensinlike protein) (GenBank Entry No. P56552; SEQ ID NO:9). In some embodiments, the protein sweetener is mabinlin I/sweet protein mabinlin-1 (GenBank Entry No. P80351; SEQ ID NO: 10), mabinlin P (also known as sweet protein mabinlin-2) (GenBank Entry No. P30233; SEQ ID NO: 11), mabinlin III (also known as sweet protein mabinlin-3) (GenBank Entry No. P80352; SEQ ID NO: 12), mabinlin IV (also known as sweet protein mabinlin-4) (GenBank Entry No. P80353; SEQ ID NO: 13) or mabinlin-1 chain A (GenBank Entry No. B9SA35; SEQ ID NO: 14).

In some embodiments, the protein sweetener is monellin.

In some embodiments, the protein sweetener is a single chain monellin protein (also known as MNEI) (SEQ ID NO:5).

In some embodiments, the protein sweetener is a sweet truffle protein. Sweet truffle proteins were recently identified from fungal proteins, e.g., M. terfezoides gleba, also called “Myd polypeptides” according to US Patent Application No. 2021/0401013, incorporated herein by reference.

In certain embodiments, the protein sweetener is a modified protein sweetener, such as those described in International Publication No. WO/2019/215730, incorporated by reference herein. The modified protein sweetener is based on the non-modified “reference protein” sweetener (amino acid sequence) and as such it should be noted that any feature/property/characterization described herein with respect to the modified protein sweetener is provided relative to the reference protein sweetener.

In some embodiments, the modified protein sweetener sequence is not found in nature and is thus called an artificial protein, or a synthetic protein or an engineered protein. The modified protein sweetener may comprise the entire amino acid sequence or part of the amino acid sequence of the naturally occurring protein (all or part of the protein's polypeptide chains) or part thereof.

As described herein, the modified protein sweetener comprises an amino acid sequence having at least one, at least two, at least three, at least four, at least five, at least six, at least ten, at least fifteen, at least eighteen amino acid substitutions relative to a reference protein sweetener (reference amino acid sequence).

In some embodiments, the modified protein sweetener comprises between one to twenty amino acid substitutions relative to a reference protein sweetener (reference amino acid sequence), at times between two to ten amino acid substitutions, at times between three to ten amino acid substitutions, at times between three to six amino acid substitutions.

In some embodiments, the modified protein sweetener comprises at least one, at least two, at least three, at least four, at least five, at least six, at least ten, at least fifteen, or at least eighteen amino acid substitutions relative to a reference protein sweetener (reference amino acid sequence), selected from the group consisting of SEQ ID NO:1, SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO: 10, SEQ ID NO:11, SEQ ID NO: 12, SEQ ID NO:13, SEQ ID NO: 14, SEQ ID NO: 15,

SEQ ID NO: 16, SEQ ID NO: 17, SEQ ID NO: 18, and SEQ ID NO: 19. In some embodiments, the modified protein sweetener comprises an amino acid sequence that is between 60% to 99%, between 65% to 99%, between 70% to 99%, between 80% to 99%, between 85% to 99%, between 90% to 99% or between 95% to 99% identical to the reference protein sweetener amino acid sequence.

In some embodiments, the modified protein sweetener comprises an amino acid sequence having at least 60%, at least 65%, at least 70%, at least 75%, at least 80%, at least 85%, at least 90%, at least 95%, or at least 99% identity with amino acid sequence selected from the group consisting of SEQ ID NO:1, SEQ ID NO:2, SEQ ID NO:3, SEQ ID NO:4, SEQ ID NO:5, SEQ ID NO: 6, SEQ ID NO:7, SEQ ID NO:8, SEQ ID NO:9, SEQ ID NO: 10, SEQ ID NO: 11, SEQ ID NO: 12, SEQ ID NO:13, SEQ ID NO:14, SEQ ID NO: 15, SEQ ID NO: 16, SEQ ID NO: 17, SEQ ID NO: 18, and SEQ ID NO: 19.

In some embodiments, the modified protein sweetener comprises an amino acid sequence having between 60% to 99%, between 65% to 99%, between 70% to 99%, between 80% to 99%, between 85% to 99%, between 90% to 99% or between 95% to 99% similarity with amino acid sequence selected from the group consisting of SEQ ID NO:1, SEQ ID NO:2, SEQ ID NO:3, SEQ ID NO:4, SEQ ID NO:5, SEQ ID NO:6, SEQ ID NO: 7, SEQ ID NO:8, SEQ ID NO:9, SEQ ID NO: 10, SEQ ID NO: 11, SEQ ID NO:12, SEQ ID NO:13 and SEQ ID NO:14, SEQ ID NO: 15, SEQ ID NO: 16, SEQ ID NO: 17, SEQ ID NO: 18, and SEQ ID NO: 19.

The modified protein sweeteners described herein have one or more improved food-related properties including improved taste attribute(s), improved structural thermal stability, improved functional thermal stability, improved pH stability, improved aqueous solubility and/or improved shelf life stability.

In some embodiments, the modified protein sweetener has one or more improved taste attributes relative to the reference protein sweetener. Exemplary taste attributes are described herein above and include bitterness, bitter linger, sourness, astringency, saltiness, metallic notes, licorice notes, mouthfeel, sweetness linger, sweetness onset, and sweetness intensity.

In some embodiments, the modified protein sweetener has improved structural thermal stability relative to the reference protein sweetener.

In some embodiments, the modified protein sweetener has improved functional thermal stability relative to the reference protein sweetener. In a particular embodiment, the modified protein sweetener may maintain sweetness at higher temperature or after exposure to higher temperature for a time which may be limited. In other words, there is no sensed change in the sweetness profile or sensory profile after exposure of the product to a temperature above room temperature, at times, up to 50° C., at times up to 100° C., or even up to 150° C.

In some embodiments, the modified protein sweetener has improved pH stability relative to the reference protein sweetener. In particular embodiments, the modified protein sweetener maintains the 3D structure and/or function after exposure of the product to any pH from 3 to 8, at times, at a pH of between 4 to 8. For example, a soda has a pH of 2.3-2.5 where some of the protein sweeteners are not stable and lose functionality immediately or after a time that is shorter than the regular shelf-life of the beverage.

In some embodiments, the modified protein sweetener has improved aqueous solubility relative to the reference protein sweetener. Methods of determining aqueous solubility are known in the art. Aqueous solubility includes both instant solubility and equilibrium solubility.

In some embodiments, the modified protein sweetener has improved shelf-life relative to the reference protein sweetener. Improved shelf-life refers to no sensed change in the sweetness (function) or physical deterioration of a product comprising the composition (e.g., color change, phase separation etc.) after exposure to a particular set of conditions.

In some embodiments, the protein sweetener is a modified Brazzein.

Modified brazzein sweeteners are discussed in the following reference, incorporated herein by reference: Assadi-Porter, Fariba M., et al. “Key amino acid residues involved in multi-point binding interactions between brazzein, a sweet protein, and the TIR2-T1R3 human sweet receptor.” Journal of Molecular Biology vol. 398, 4 (2010): 584-99.

A modified brazzein protein sweetener comprises at least one amino acid substitution selected from the group consisting of 1Qdeletion, D2E, C4A, K5A, K5R, K6A, K6D, Y8A, K15A, C16A, Q17A, Q17C, Q17N, D29A, D29K, D29N, K30D, K30R, K30A, H31A, H31R, R33A, R33D, R33K, E36A, E36K, Y39A, E36Q, C37A, D40K, E41A, E41R, E41Q, E41K, K42A, K42E, R43A, R43K, R43E, R43N, Y54deletion, D50A, D50N, Y54H, and Y54W.

In some embodiments, the protein sweetener is a modified MNEI.

In a particular embodiment, the modified MNEI protein sweetener comprises Y65R substitution. In a more particular embodiment, the modified MNEI protein sweetener has a single amino acid substitution of Y65R as described in Esposito, V., et al., The Importance of Electrostatic Potential in The Interaction of Sweet Proteins with the Sweet Taste Receptor. J. Mol. Biol. 360, 448-456 (2006). (SEQ ID. NO: 17)

Additional variants are discussed in the following references, incorporated herein by reference: Liu Q, Li L, Yang L, Liu T, Cai C, Liu B. Modification of the Sweetness and Stability of Sweet-Tasting Protein Monellin by Gene Mutation and Protein Engineering. Biomed Res Int. 2016;2016:3647173; Samish, I. Itamar, K. Hecht, D. Taste and flavor-modifier proteins, 2019, U.S. Pat. No. 20,210,139546; Iijima, H. Sone, T. Method for producing single stranded monellin, 1991, JP05070494 A; Castiglia D, Leone S, Tamburino R, Sannino L, Fonderico J, Melchiorre C, Carpentieri A, Grillo S, Picone D, Scotti N. High-level production of single chain monellin mutants with enhanced sweetness and stability in tobacco chloroplasts. Planta. 2018 August; 248 (2): 465-476; Malhotra P, Jethva P N, Udgaonkar J B. Chemical Denaturants Smoothen Ruggedness on the Free Energy Landscape of Protein Folding. Biochemistry. 2017 Aug. 8;56 (31): 4053-4063; Sung Y H, Shin J, Chang H J, Cho J M, Lee W. Solution structure, backbone dynamics, and stability of a double mutant single-chain monellin. structural origin of sweetness. J Biol Chem. 2001 Jun. 1; 276 (22): 19624-30; Leone S, Pica A, Merlino A, Sannino F, Temussi P A, Picone D. Sweeter and stronger: enhancing sweetness and stability of the single chain monellin MNEI through molecular design. Sci Rep. 2016 Sep. 23;6:34045; Templeton C M, Ostovar pour S, Hobbs J R, Blanch E W, Munger S D, Conn G L. Reduced sweetness of a monellin (MNEI) mutant results from increased protein flexibility and disruption of a distant poly-(L-proline) II helix. Chem Senses. 2011 June;36 (5): 425-34; Zhao M, Xu X, Liu B. Structure basis of the improved sweetness and thermostability of a unique double-sites single-chain sweet-tasting protein monellin (MNEI) mutant. Biochimie. 2018 November; 154:156-163.

A modified MNEI protein sweetener comprises at least one amino acid substitution selected from the group consisting of G2M, E2N, E2M, E2D, E2Q, E2R, E2K, D8E, D8N, 18T, P10A, F11A, T12A, N14A, N14K, L15A, G16A, K17A, F18A, A19E, V20A, D21A, N25T, E22A, E23A, E23N, E23D, E23Q, E23R, E23K, E23V, N24K, 126A, Q28K, R31T, V37A, R40E, R40D, R40K, C41A, C41S, C41T, E49N, N50E, V63A, Y65F, Y65W, Y65H, Y65V, Y65I, Y65L, Y65M, Y65C, Y65A, Y65T, Y65S, Y65P, Y65G, Y65K, Y65R, S67N, D68N, D68T, and R84L.

In another particular embodiment, the modified MNEI protein sweetener comprises at least three amino acid substitutions selected from the group consisting of G2M, E2N, E2M, E2D, E2Q, E2R, E2K, D8E, D8N, 18T, P10A, F11A, T12A, N14A, N14K, L15A, G16A, K17A, F18A, A19E, V20A, D21A, N25T, E22A, E23A, E23N, E23D, E23Q, E23R, E23K, E23V, N24K, I26A, Q28K, R31T, V37A, R40E, R40D, R40K, C41A, C41S, C41T, E49N, N50E, V63A, Y65F, Y65W, Y65H, Y65V, Y651, Y65L, Y65M, Y65C, Y65A, Y65T, Y65S, Y65P,

Y65G, Y65K, Y65R, S67N, D68N, D68T, and R84L.

In some embodiments, the at least three substitutions are selected from the group consisting of E2N, E23V, E23A, Y65K, and Y65R. In some embodiments, the at least three substitutions are E2N, E23V and Y65K. In some embodiments, the at least three substitutions are E2N, E23A and Y65R.

In particular embodiments, the protein sweetener is a modified MNEI protein sweetener having one of the following amino acid sequences:

(SEQ ID NO: 15)
GNWEUDIGPFTQNLGKFAVDEVNKIGQYGRLTFNKVIRPCMKKTIYENE
GFREIKGYEYQLYVKASDKLFRADISEDYKTRGRKLLRFNGPVPPP,
or
(SEQ ID NO: 16)
GNWEIIDIGPFTQNLGKFAVDEANKIGQYGRLTFNKVIRPCMKKTIYEN
EGFREIKGYEYQLYVRASDKLFRADISEDYKTRGRKLLRFNGPVPPP.

In other particular embodiments, the protein sweetener is a modified MNEI protein sweetener with the following mutations:

E23Q, Q28K, C41S, Y65R (Leone, S. et al. Sweeter and stronger: enhancing sweetness and stability of the single chain monellin MNEI through molecular design. Sci. Rep. 6, 34045; doi: 10.1038/srep34045 (2016), PDB 5LC7) (SEQ ID NO: 18), or

Q28K, C41S, and Y65R (Leone, S. et al. Sweeter and stronger: enhancing sweetness and stability of the single chain monellin MNEI through molecular design. Sci. Rep. 6, 34045; doi: 10.1038/srep34045 (2016), PDB 5LC6 (SEQ ID. NO: 19).

In some embodiments, the protein sweetener is a modified thaumatin.

Modified thaumatin sweeteners are discussed in the following references, incorporated herein by reference: Ohta K, Masuda T, Ide N, Kitabatake N. Critical molecular regions for elicitation of the sweetness of the sweet-tasting protein, thaumatin I. FEBS J. 2008 July; 275 (14): 3644-52; Ohta K, Masuda T, Tani F, Kitabatake N. Introduction of a negative charge at Arg82 in thaumatin abolished responses to human TIR2-TIR3 sweet receptors. Biochem Biophys Res Commun. 2011 Sep. 16; 413 (1): 41-5; Masuda T, Kigo S, Mitsumoto M, Ohta K, Suzuki M, Mikami B, Kitabatake N, Tani F. Positive Charges on the Surface of Thaumatin Are Crucial for the Multi-Point Interaction with the Sweet Receptor. Front Mol Biosci. 2018 Feb. 13;5:10; and Masuda T, Ohta K, Ojiro N, Murata K, Mikami B, Tani F, Temussi P A, Kitabatake N. A Hypersweet Protein: Removal of The Specific Negative Charge at Asp21 Enhances Thaumatin Sweetness. Sci Rep. 2016 Feb. 3;6:20255.

A modified thaumatin comprises at least one amino acid substitution selected from the group consisting of K19A, D21N, E42Q, K49A, D55N, D59A, D60A, K67A, K67E, R76A, K78A, R79A, R82A, R82E, R82Q, R82K, E89Q, K106A, K137A, and K163A.

In particular embodiments, the beverage comprise at least two protein sweeteners described herein. It has been found that certain combinations of protein sweeteners provide synergy, in particular with respect to sweetness intensity and/or mouthfeel.

In one embodiment, the beverage comprises thaumatin and brazzein. In another embodiment, the beverage comprises thaumatin and MNEI. In another embodiment, the beverage comprises brazzein and MNEI. The protein sweeteners are optionally modified proteins as discussed above.

The concentration of the at least one protein sweetener in the beverage can vary. The at least one protein sweetener is present in an amount sufficient to make the diet beverage taste more like a sucrose-sweetened beverage. In certain embodiments, the at least one protein sweetener is present in a sweetening amount, the precise concentration of which will depend on the identity of the protein sweetener. In certain other embodiments, the at least one protein sweetener is present in the beverage in a concentration at or below the protein sweetener's sweetness recognition threshold concentration.

In some embodiments, the at least one protein sweetener is present in a concentration from about 1 ppm to about 20 ppm, such as, for example, from about 5 ppm to about 20 ppm, from about 5 ppm to about 15 ppm, from about 5 ppm to about 10 ppm, from about 10 ppm to about 20 ppm, from about 10 ppm to about 15 ppm or from about 15 ppm to about 20 ppm.

In other embodiments, the at least one protein sweetener is present in a concentration from about 1 ppm to about 1,000 ppm, such as, for example, from about 1 ppm to about 600 ppm, from about 1 ppm to about 500 ppm, from about 1 ppm to about 250 ppm, from about 1 ppm to about 100 ppm, from about 1 ppm to about 50 ppm, from about 50 ppm to about 1,000 ppm, from about 50 ppm to about 600 ppm, from about 50 ppm to about 250 ppm, or from about 50 ppm to about 100 ppm.

Thaumatin is preferably present in a concentration from about 1 ppm to about 10 ppm, such as, for example, from about 2 ppm to about 8 ppm, from about 4 ppm to about 8 ppm or about 6 ppm to about 8 ppm.

Brazzein is preferably present in a concentration from about 1 ppm to about 50 ppm, such as, for example, from about 10 ppm to about 40 ppm, from about 10 ppm to about 30 ppm, or from about 10 ppm to about 20 ppm.

Monellin is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, from about 1 ppm to about 25 ppm, from about 1 ppm to about 10 ppm or from about 1 ppm to about 5 ppm.

Mabinlin is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

Pentadin is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

Curculin (or Neoculin) is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

Miraculin is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

Egg lysozyme is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

Sweet truffle protein is preferably present in a concentration from about 1 ppm to about 1,000 ppm, such as, for example, from about 1 ppm to about 500 ppm, about 1 ppm to about 250 ppm, about 1 ppm to about 100 ppm, about 1 ppm to about 50 ppm, or about 1 ppm to about 25 ppm.

In certain embodiments, the at least one protein sweetener is derived from katemfe. In certain embodiments, the at least one protein sweetener is derived from serendipity berry. In other embodiments, protein sweeteners, including modified protein sweeteners, can be produced by any method known in the art, for example synthetically, by extraction from natural sources, recombinant DNA technology or by protein production in microorganisms via fermenters or in plants or in plant callus or other bioreactors. In some embodiments, the protein sweeteners may be produced in bacteria, such as E. Coli. In some other embodiments, the protein sweeteners may be produced yeast, such as Saccharomyces cerevisiae or Pichia pastoris.
B. Non-Protein Sweetener

The diet beverage described herein includes at least one non-protein sweetener in addition to the at least one protein sweetener. A sweetener composition comprises at least one protein sweetener and at least one non-protein sweetener, as discussed below.

The non-protein sweetener is present in a sweetening amount. The particular concentration of the non-protein sweetener will vary based on the identity of the particular non-protein sweetener, the beverage matrix, and the desired level of sweetness.

In one embodiment, the non-protein sweetener is a steviol glycoside or steviol glycoside mixture. The steviol glycoside can be natural or synthetic.

The steviol glycoside can be provided in pure form or as part of a mixture. Exemplary steviol glycosides include, but are not limited to, rebaudioside M, rebaudioside D, rebaudioside A, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides and combinations thereof.

In a particular embodiment, the non-protein sweetener is a steviol glycoside or steviol glycoside mixture comprising rebaudioside A. In certain embodiments, the rebaudioside A has a purity of at least about 55% (i.e., at least about 55% by weight on a dry basis). In certain embodiments, the rebaudioside A has a purity of at least about 95%.

The steviol glycoside mixture sweetener typically has a total steviol glycoside content of about 95% by weight or greater on a dry basis. The remaining 5% comprises other non-steviol glycoside compounds, e.g., by-products from extraction or purification processes. In some embodiments, the steviol glycoside mixture sweetener has a total steviol glycoside content of about 96% or greater, about 97% or greater, about 98% or greater or about 99% or greater.

In certain embodiments, a steviol glycoside mixture comprises at least about 5% of a particular steviol glycoside by weight, such as, for example, at least about 10%, at least about 20%, at least about 30%, at least about 40%, at least about 50%, at least about 60%, at least about 70%, at least about 80%, at least about 90%, at least about 95% or at least about 97%.

In exemplary embodiments, the steviol glycoside mixture comprises at least about 50% of a particular steviol glycoside by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In one embodiment, the non-protein sweetener is a steviol glycoside mixture comprising rebaudioside A. For example, the steviol glycoside mixture may comprise at least about 5% rebaudioside A by weight, such as, for example, at least about 10%, at least about 20%, at least about 30%, at least about 40%, at least about 50%, at least about 60%, at least about 70%, at least about 80%, at least about 90%, at least about 95% or at least about 97%.

In another embodiment, the steviol glycoside mixture may comprise at least about 50% rebaudioside A by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In another particular embodiment, the non-protein sweetener is a steviol glycoside mixture comprising rebaudioside M. The steviol glycoside mixture may comprise at least about 5% rebaudioside M by weight, such as, for example, at least about 10%, at least about 20%, at least about 30%, at least about 40%, at least about 50%, at least about 60%, at least about 70%, at least about 80%, at least about 90%, at least about 95% or at least about 97%.

In one embodiment, the steviol glycoside mixture may comprise at least about 50% rebaudioside M by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In another particular embodiment, the non-protein sweetener is a steviol glycoside mixture comprising rebaudioside D. The steviol glycoside mixture may comprise at least about 5% rebaudioside D by weight, such as, for example, at least about 10%, at least about 20%, at least about 30%, at least about 40%, at least about 50%, at least about 60%, at least about 70%, at least about 80%, at least about 90%, at least about 95% or at least about 97%.

In one embodiment, the steviol glycoside mixture may comprise at least about 50% rebaudioside D by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In certain embodiments, the steviol glycoside mixture comprises rebaudioside M and rebaudioside D.

In other embodiments, the steviol glycoside mixture is A95, a specific blend of rebaudiosides D, M, A, N, O and, optionally, E, described in WO 2017/059414 (incorporated by reference herein). A95 comprises rebaudiosides D, M, A, N, O and, optionally, E, wherein the total steviol glycoside content is about 95% or greater by weight, wherein rebaudioside D accounts for from about 55% to about 70% of the total steviol glycoside content by weight, rebaudioside M accounts for from about 18% to about 30% total steviol glycoside content by weight, rebaudioside A accounts for from about 0.5% to about 4% of the steviol glycoside content by weight, rebaudioside N accounts for from about 0.5% to about 5% of the steviol glycoside content by weight, rebaudioside O accounts for from about 0.5% to about 5% of the total steviol glycoside content by weight and, optionally, rebaudioside E accounts for from about 0.2% to about 2% total steviol glycoside content by weight.

The concentration of the steviol glycoside sweetener or steviol glycoside mixture sweetener in the beverage can vary from about 25 ppm to about 600 ppm, such as, for example, from about 25 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm or from about 500 ppm to about 600 ppm.

In another embodiment, the non-protein sweetener is a mogroside or mogroside mixture. The mogroside can be natural or synthetic.

The mogroside can be provided in pure form or as part of mixture. Exemplary mogrosides include, but are not limited to, any of grosmogroside I, mogroside IA, mogroside IE, 11-oxomogroside IA, mogroside II, mogroside II A, mogroside II B, mogroside II E, 7-oxomogroside II E, mogroside III, Mogroside IIIe, 11-deoxymogroside III, Mogroside IV, 11-oxomogroside IV, 11-oxomogroside IV A, Mogroside V, Isomogroside V, 11-deoxymogroside V, 7-oxomogroside V, 11-oxomogroside V, Isomogroside V, Mogroside VI, Mogrol, 11-oxomogrol, Siamenoside I and combinations thereof.

Additional exemplary mogrosides include those described in U.S. Patent Application Publication 2016039864. In a particular embodiment, the mogroside is selected from (3β, 9β, 10α, 11α,24R)-3-[(4-O-β-D-glucospyranosyl-6-O-β-D-glucopyranosyl]-25-hydroxyl-9-methyl -19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl -β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl-β-D-glucopyranosyl) oxy]-25- hydroxy-9-methyl-19-norlanost-5-en-24-yl-[2-O-β-D-glucopyranosyl-6-O-β-D-glucopyranosyl]-β-D-glucopyranoside) and combinations thereof.

In certain embodiments, a mogroside mixture comprises at least about 5% of a particular mogroside by weight, such as, for example, at least about 10%, at least about 20%, at least about 30%, at least about 40%, at least about 50%, at least about 60%, at least about 70%, at least about 80%, at least about 90%, at least about 95% or at least about 97%.

In exemplary embodiments, the mogroside mixture comprises at least about 50% of a particular mogroside by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In other embodiments, the mogroside mixture has a total mogroside content of about 95% by weight or greater on a dry basis. In some embodiments, the mogroside mixture has a total mogroside content of about 96% or greater, about 97% or greater, about 98% or greater or about 99% or greater.

In one particular embodiment, the non-protein sweetener is a mogroside mixture comprising siamenoside I. The mogroside mixture may comprise at least about 5% siamenoside I by weight, such as, for example, at least about 10%, at least about 20%, at least about 30%, at least about 40%, at least about 50%, at least about 60%, at least about 70%, at least about 80%, at least about 90%, at least about 95% or at least about 97%.

The mogroside mixture may comprise at least about 50% siamenoside I by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

In one particular embodiment, the non-protein sweetener is a mogroside mixture comprising mogroside V. The mogroside mixture may comprise at least about 5% mogroside V by weight, such as, for example, at least about 10%, at least about 20%, at least about 30%, at least about 40%, at least about 50%, at least about 60%, at least about 70%, at least about 80%, at least about 90%, at least about 95% or at least about 97%.

The mogroside mixture may comprise at least about 50% mogroside V by weight, such as, for example, from about 50% to about 99%, from about 50% to about 80%, from about 50% to about 70%, from about 50% to about 60%, from about 60% to about 99%, from about 60% to about 80%, from about 60% to about 70%, from about 70% to about 99%, from about 70% to about 80% and from about 80% to about 99%.

The concentration of the mogroside sweetener or mogroside mixture sweetener in the beverage can vary from about 25 ppm to about 600 ppm, such as, for example, from about 25 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm or from about 500 ppm to about 600 ppm.

In another embodiment, the non-protein sweetener is at least one carbohydrate sweetener. Suitable carbohydrate sweeteners include, but are not limited to, sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, allulose, sorbose, tagatose, mannoheptulose, sedoheltulose, octolose, fucose, rhamnose, arabinose, turanose, sialose, high fructose corn syrup, and combinations thereof.

The concentration of the at least one carbohydrate sweetener can vary from about 1.5 wt % to about 12 wt %, such as, for example, from about 5 wt % to about 12 wt %, from about 5 wt % to about 11 wt % or from about 5 wt % to about 10 wt %.

In one embodiment, the non-protein sweetener is at least one synthetic sweetener. Suitable synthetic sweeteners include, but are not limited to, sucralose, potassium acesulfame, aspartame, alitame, saccharin, neohesperidin dihydrochalcone, cyclamate, neotame, advantame, glycyrrhizin, salts thereof and combinations thereof.

The concentration of the at least one synthetic sweetener can vary from about 1 ppm to about 500 ppm, such as, for example, from about 1 ppm to about 400 ppm, about 1 ppm to about 300 ppm, from about 1 ppm to about 200 ppm, from about 1 ppm to about 100 ppm, from about 1 ppm to about 50 ppm or from about 1 ppm to about 25 ppm.

In one embodiment, the non-protein sweetener is at least one sugar alcohol. Suitable sugar alcohols include, but are not limited to, sorbitol, mannitol, lactitol, maltitol, xylitol, erythritol and combinations thereof.

The at least one sugar alcohol can be present in an amount from about 0.1% to about 3.5% of the finished beverage by weight, such as, for example, from about 0.5% to about 3.5%, from about 0.5% to about 3.0%, from about 0.5% to about 2.5%, from about 0.5% to about 2.0%, from about 0.5% to about 1.5%, from about 0.5% to about 1.0%, from about 1.0% to about 3.5%, from about 1.0% to about 3.0%, from about 1.0% to about 2.5%, from about 1.0% to about 2.0%, from about 1.0% to about 1.5%, from about 1.5% to about 3.5%, from about 1.5% to about 3.0%, from about 1.5% to about 2.5%, from about 1.5% to about 2.0%, from about 2.0% to about 3.5%, from about 2.0% to about 3.0%, from about 2.0% to about 2.5%, from about 2.5% to about 3.5%, from about 2.5% to about 3.0% or from about 3.0% to about 3.5%.

In one embodiment, the non-protein sweetener is at least one rare sugar. Suitable rare sugars include, but are not limited to, allulose, allose, tagatose, furanose, arabinose and combinations thereof.

The at least one rare sugar can be present in an amount from about 0.1% to about 3.5% of the finished beverage by weight, such as, for example, from about 0.5% to about 3.5%, from about 0.5% to about 3.0%, from about 0.5% to about 2.5%, from about 0.5% to about 2.0%, from about 0.5% to about 1.5%, from about 0.5% to about 1.0%, from about 1.0% to about 3.5%, from about 1.0% to about 3.0%, from about 1.0% to about 2.5%, from about 1.0% to about 2.0%, from about 1.0% to about 1.5%, from about 1.5% to about 3.5%, from about 1.5% to about 3.0%, from about 1.5% to about 2.5%, from about 1.5% to about 2.0%, from about 2.0% to about 3.5%, from about 2.0% to about 3.0%, from about 2.0% to about 2.5%, from about 2.5% to about 3.5%, from about 2.5% to about 3.0% or from about 3.0% to about 3.5%.

In certain embodiments, a sweetener composition comprises at least one protein sweetener and at least one of the following non-protein sweeteners: a carbohydrate sweetener, a steviol glycoside or steviol glycoside mixture sweetener, a mogroside or mogroside mixture sweetener, a synthetic sweetener, a sugar alcohol sweetener, or a rare sugar sweetener.
C. Beverage Formulations

The present invention provides a diet beverage or beverage product comprising at least one protein sweetener and at least one non-protein sweetener.

Beverage concentrates and beverage syrups are prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverages comprise a beverage matrix, i.e., the basic ingredient in which the ingredients—including the at least one protein sweetener—are dissolved. In one embodiment, a diet beverage comprises water of beverage quality as the matrix, such as, for example deionized water, distilled water, reverse osmosis water, carbon-treated water, purified water, demineralized water and combinations thereof, can be used. Additional suitable beverage matrices include, but are not limited to phosphoric acid, phosphate buffer, citric acid, citrate buffer (a mixture of citric acid and citrate salts) and carbon-treated water.

Suitable beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry, and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

Alcoholic beverages are also contemplated herein, both carbonated and non-carbonated alcoholic beverages. Alcoholic beverages that can be used in the present invention are not particularly limited and may be any alcohol that is drinkable. Examples include brewed alcohols, spirits (e.g., gin, vodka, rum, tequila), liquors, whiskeys (e.g., whiskey, brandy), shochu, and fermented beverages (e.g., mead, sake, wine, and beer). Additional alcoholic beverages include champagne, ciders, wine coolers, and hard seltzers.

In another embodiment, the beverage is a plant protein-containing beverage, e.g., soy, oat or nut protein. Exemplary plant protein-containing beverages include, but are not limited to, coconut milk, oat milk, cashew milk, almond milk, and soy milk.

A non-limiting example of the pH range of the diet beverage may be from about 1.8 to about 10. A further example includes a pH range from about 2 to about 5. In a particular embodiment, the pH of beverage can be from about 2.5 to about 4.2. One of skill in the art will understand that the pH of the beverage can vary based on the type of beverage. Dairy beverages, for example, can have pHs greater than 4.2.

The titratable acidity of a diet beverage may, for example, range from about 0.01 to about 1.0% by weight of beverage.

In one embodiment, the sparkling or carbonated diet beverage product has an acidity from about 0.01 to about 1.0% by weight of the beverage, such as, for example, from about 0.05% to about 0.25% by weight of beverage.

The carbonation of a sparkling beverage product has 0 to about 2% (w/w) of carbon dioxide or its equivalent, for example, from about 0.1 to about 1.0% (w/w).

The diet beverage can be caffeinated or non-caffeinated.

The temperature of a beverage may, for example, range from about 4° C. to about 100° C., such as, for example, from about 4° C. to about 25° C.

The beverage can be a mid-calorie beverage that has up to about 60 calories per 8 oz. serving.

The beverage can be a low-calorie beverage that has up to about 40 calories per 8 oz. serving.

The beverage can be a zero-calorie that has less than about 5 calories per 8 oz. serving.

The sweetness of a non-sucrose sweetener can be measured against a sucrose reference by determining the non-sucrose sweetener's sucrose equivalence (SE). Typically, taste panelists are trained to detect sweetness of reference sucrose solutions containing between 1-15% sucrose (w/v). Other non-sucrose sweeteners are then tasted at a series of dilutions to determine the concentration of the non-sucrose sweetener that is as sweet as a given percent sucrose reference. For example, if a 1% solution of a non-sucrose sweetener is as sweet as a 10% sucrose solution, then the sweetener is said to be 10 times as potent as sucrose, and has 10% sucrose equivalence. In one embodiment, the diet beverage has a sucrose equivalence of about 1% (w/v), such as, for example, about 2%, about 3%, about 4%, about 5%, about 6%, about 7%, about 8%, about 9%, about 10%, about 11%, about 12%, about 13%, about 14% or any range between these values.

In another embodiment, the diet beverage has a SE from about 2% to about 14%, such as, for example, from about 2% to about 10%, from about 2% to about 5%, from about 5% to about 15%, from about 5% to about 10% or from about 10% to about 15%.

The amount of sucrose, and thus another measure of sweetness, in a reference solution may be described in degrees Brix (° Bx). One degree Brix is 1 gram of sucrose in 100 grams of solution and represents the strength of the solution as percentage by weight (% w/w). In embodiments where the beverage comprises sucrose, the beverage can be from about 4° Bx to a about 11° Bx, from about 4° Bx to about 10° Bx, from about 4° Bx to about 8° Bx, from about 4° Bx to about 6° Bx, from about 5° Bx to about 11° Bx, from about 5° Bx to about 10° Bx, from about 5° Bx to about 8° Bx, from about 6° Bx to about 11° Bx, from about 6° Bx to about 10° Bx, from about 6° Bx to about 8° Bx, from about from about 7° Bx to about 11° Bx, from about 7° Bx to about 10° Bx, from about 8° Bx to about 11° Bx, from about 8° Bx to about 10° Bx, from about 9° Bx to about 11° Bx, from about 9° Bx to about 10° Bx or from about 10° Bx to about 11° Bx.

In a particular embodiment, the diet beverage is a diet juice beverage. In certain embodiments, the diet juice beverage comprises a citrus juice selected from the group consisting of orange juice, grapefruit juice, lemon juice, lime juice, tangerine juice, and combinations thereof. In a particular embodiment, the diet juice beverage comprises orange juice. In another particular embodiment, the only citrus juice present is orange juice. The citrus juice can contain pulp or be pulp-free.

In some embodiments, the orange juice is sucrose-sweetened orange juice with Brix from about 8° Bx to about 12° Bx, from about 8° Bx to about 11° Bx, from about 8° Bx to about 10° Bx, from about 8° Bx to about 9° Bx, from about 9° Bx to about 12° Bx, from about 9° Bx to about 11° Bx, from about 9° Bx to about 10° Bx, from about 10° Bx to about 12° Bx, from about 10 to about 11° Bx or from about 11° Bx to about 12° Bx.

In other embodiments, the orange juice is a reduced-sugar orange juice sweetened with sucrose and at least one steviol glycoside mixture in a sweetening amount with a Brix from about 4° Bx to about 8° Bx, preferably about 6° Bx. The at least one steviol glycoside mixture is preferably selected from the group consisting of a steviol glycoside mixture comprising at least 50% rebaudioside A by weight, a steviol glycoside mixture comprising at least 95% rebaudioside A by weight, and a combination thereof. When present in combination, the ratio of the two steviol glycoside mixture sweeteners can vary from about 10:1 to about 1:10, such, as, for example, about 9:1, about 8:1, about 7:1, about 6:1, about 5:1, about 4:1, about 3:1, about 2:1, or about 1:1. In a particular embodiment, the ratio of the two steviol glycoside mixtures is about 1:1. The concentration of the at least one steviol glycoside mixture in the reduced-sugar orange juice is from about 50 ppm to about 200 ppm, such as, for example, from about 90 ppm to about 200 ppm, from about 100 ppm to about 200 ppm, from about 110 ppm to about 200 ppm, from about 125 ppm to about 200 ppm, from about 150 ppm to about 200 ppm or from about 175 ppm to about 200 ppm. These concentration ranges can refer to the individual steviol glycoside mixture or the combination of both steviol glycoside mixtures.

In certain embodiments, the diet beverage comprises at least about 10% juice, such as, for example, at least about 20%, at least about 30%, at least about 40%, at least about 50%, or at least about 60%. In particular embodiments, the juice is orange juice.

In certain embodiments, a diet orange juice beverage of the present invention comprises sucrose-sweetened orange juice and at least one protein sweetener described herein. The Brix of the sucrose-sweetened orange juice is from about 8° Bx to about 10.5° Bx, from about 9° Bx to about 10.5° Bx or from about 10° Bx to about 10.5° Bx. The at least one protein sweetener is preferably thaumatin in a concentration of about 1 ppm to about 10 ppm, more preferably from about 2 ppm to about 8 ppm, still more preferably from about 2 ppm to about 6 ppm, even more preferably from about 4 ppm to about 6 ppm. The sucrose equivalence of the diet orange juice beverage is from about 10.5 to about 12.5% SE. The diet orange juice beverage has less calories and improved mouthfeel compared to the beverage in the absence of the at least one protein sweetener.

In certain embodiments, a diet orange juice beverage of the present invention comprises a reduced-sugar orange juice comprising sucrose and at least one steviol glycoside mixture in a sweetening amount and having a Brix from about 4° Bx to about 8° Bx, preferably about 6° Bx, and at least one protein sweetener described herein. The at least one protein sweetener is preferably thaumatin in a concentration of about 1 ppm to about 10 ppm, more preferably from about 2 ppm to about 8 ppm, still more preferably from about 2 ppm to about 6 ppm, even more preferably from about 4 ppm to about 6 ppm. The sucrose equivalence of the diet orange juice beverage can be from about 10.5 to about 13.0% SE. The diet orange juice beverage has less calories and improved mouthfeel compared to a reduced-sugar orange juice beverage in the absence of the at least one protein sweetener.

In a particular embodiment, the diet beverage is a diet sparkling beverage. Particularly desirably sparkling beverages are citrus-flavored sparkling beverages, e.g., lemon-lime flavored sparkling beverages and orange-flavored sparkling beverages.

In certain embodiments, a diet sparkling beverage comprises sucrose, at least one protein sweetener and at least one steviol glycoside sweetener, e.g., a steviol glycoside mixture comprising at least about 80% rebaudioside M by weight. The at least one protein sweetener is preferably brazzein. The concentration of brazzein can be from about 10 ppm to about 20 ppm. The concentration of the steviol glycoside sweetener can be from about 50 ppm to about 600 ppm, more preferably from about 100 ppm to about 300 ppm, even more preferably from about 100 ppm to about 200 ppm. The Brix of the diet sparkling beverage is from about 3° Bx to about 8° Bx, such as, for example, about 4° Bx to about 6° Bx. The sucrose equivalence of the diet sparkling beverage is at least about 10° Bx. The diet sparkling beverage has less calories and improved mouthfeel compared to a diet sparkling beverage in the absence of the at least one protein sweetener. The diet sparkling beverages of the present invention may also comprise citric acid and/or malic acid. As would be understood by a skilled person, sparkling beverages typically contain citric acid. It has been found that when from about 2-10 wt % of the citric acid is replaced with malic acid, the overall flavor profile is more balanced and similar to a full sugar-sweetened beverage.

In another particular embodiment, a beverage comprises (i) at least two protein sweeteners selected from thaumatin, brazzein, and MNEI and (ii) at least one non-protein sweetener. Exemplary non-protein sweeteners include stevia or steviol glycoside sweeteners, mogroside sweeteners, and synthetic sweeteners.

In a particular embodiment, a beverage comprises (i) at least two protein sweeteners selected from thaumatin, brazzein, and MNEI and (ii) at least one synthetic sweetener in an amount effective to provide from about 4% to about 8% sucrose equivalence. The thaumatin may be present in a concentration from about 1 ppm to about 10 ppm, the brazzein may be present in a concentration from about 1 ppm to about 50 ppm, and the MNEI may be present in a concentration from about 1 ppm to about 10 ppm.

In a more particular embodiment, a beverage comprises (i) at least two protein sweeteners selected from thaumatin, brazzein, and MNEI and (ii) at least one synthetic sweetener selected from the group consisting of sucralose, potassium acesulfame, aspartame, alitame, saccharin, cyclamate, neotame, and advantame, wherein the at least one synthetic sweetener is present in an amount effective to provide from about 4% to about 8% sucrose equivalence. The thaumatin may be present in a concentration from about 1 ppm to about 10 ppm, the brazzein may be present in a concentration from about 1 ppm to about 50 ppm, and the MNEI may be present in a concentration from about 1 ppm to about 10 ppm.

In an even more particular embodiment, a beverage comprises (i) thaumatin and brazzein and (ii) sucralose and potassium acesulfame, wherein (ii) is present in an amount effective to provide from about 4% to about 8% sucrose equivalence. The thaumatin may be present in a concentration from about 1 ppm to about 10 ppm and the brazzein may be present in a concentration from about 1 ppm to about 50 ppm.

In a still further particular embodiment, a beverage comprises (i) thaumatin and MNEI and (ii) sucralose and potassium acesulfame, wherein (ii) is present in an amount effective to provide from about 4% to about 8% sucrose equivalence. The thaumatin may be present in a concentration from about 1 ppm to about 10 ppm and the MNEI may be present in a concentration from about 1 ppm to about 10 ppm.

In a still further particular embodiment, a beverage comprises (i) brazzein and MNEI and (ii) sucralose and potassium acesulfame, wherein (ii) is present in an amount effective to provide from about 4% to about 8% sucrose equivalence. The brazzein may be present in a concentration from about 1 ppm to about 50 ppm and the MNEI may be present in a concentration from about 1 ppm to about 10 ppm.

The diet beverages of the present invention may also comprise at least one salt having a cation selected from Ca²⁺ and Mg²⁺ and an anion selected from lactate, citrate, lactate gluconate, anhydrous and hydrate forms thereof, and combinations thereof. The at least one salt further modulates one or more taste attributes of the diet beverage to make the beverage taste more like a sucrose-sweetened beverage compared to a corresponding beverage in the absence of the salt. In some embodiments, two or more salts are needed to achieve a diet beverage with more sucrose-sweetened characteristics.

The concentration of the at least one salt described herein can vary from about 100 ppm to about 1,000 ppm, or from about 0.1 mM to about 5 mM.

In some embodiments, the diet beverages of the present invention comprise salts having cations selected from Ca²⁺ and Mg²⁺. The anion component of each salt can be selected from gluconate (C₆H₁₁O₇⁻¹), citrate (C₆H₅O₇⁻³), hydrogen citrate (C₆H₆O₇⁻²), dihydrogen citrate (C₆H₇O₇⁻¹), malate (C₄H₆O₅⁻²), hydrogen malate (C₄H₇O₅⁻¹), maleate (C₄H₂O₄⁻²), hydrogen maleate (C₄H₃O₄⁻¹), fumarate (C+H₂O₄⁻²), hydrogen fumarate (C₄H₃O₄⁻¹), succinate (C₄H₄O₄−₂), hydrogen succinate (C₄H₅O₄⁻¹), glutarate (C₅H₆O₄⁻²), hydrogen glutarate (C₄H₇O₄⁻¹), adipate C₆H₈O₄⁻²), hydrogen adipate C₆H₉O₄⁻¹), lactate (C₃H₅O₃⁻¹), tartrate (C₄H₄O₆⁻²), bitartrate (C₄H₅O₆⁻¹), phosphate (PO₄⁻³), monohydrogen phosphate (HPO₄⁻²), dihydrogen phosphate (H₂PO₄⁻), fluoride (F⁻), sulfate (SO₄⁻²), bisulfate (HSO₄⁻¹), nitrate (NO₃⁻), carbonate (CO₃⁻²), bicarbonate (HCO₃⁻), glycerate (C₃H₅O₄⁻¹), glycolate (C₂H₃O₃⁻¹), or combinations thereof.

In preferred embodiments, the present diet beverages do not use chloride salts (Cl⁻) of Ca²⁺ and Mg²⁺, i.e., the salts are not MgCl₂ and/or CaCl₂.

Preferred anions for the present diet beverages are lactate, citrate, gluconate and combination thereof.

The salts can be used in their anhydrate or hydrate forms.

In particular embodiments, the at least one salt is selected from magnesium lactate, magnesium citrate, calcium citrate, calcium lactate and calcium gluconate.

In more particular embodiments, the at least one salt is selected from magnesium lactate dihydrate, trimagnesium dicitrate anhydrous, tricalcium dicitrate tetrahydrate, calcium lactate pentahydrate, dicalcium lactate gluconate monohydrate and combinations thereof.

In embodiments where the at least one salt comprises a Mg²⁺ cation-containing salt and a Ca²⁺ cation-containing salt, the weight ratio of the Mg²⁺ cation-containing salt to the Ca²⁺ cation-containing salt can be from about 5:1 to about 1:1, such as, for example, from about 4:1 to about 1:1, from about 3:1 to about 1:1 or from about 2:1 to about 1:1. In a particular embodiment the weight ratio is from about 3:1 to about 1:1.

The concentration of the at least one salt in the diet beverage can vary. An exemplary concentration range is from about 100 ppm to about 1,000 ppm, such as, for example, from about 100 ppm to about 900 ppm, from about 100 ppm to about 800 ppm, from about 100 ppm to about 700 ppm, from about 100 ppm to about 600 ppm, from about 100 ppm to about 500 ppm, from about 100 ppm to about 400 ppm, from about 100 ppm to about 300 ppm and from about 100 ppm to about 200 ppm.

The concentration of the at least one salt can also be described in millimolar (mM). The at least one salt described herein is preferably present in an amount from about 0.1 mM to about 5 mM, from about 0.1 mM to about 4 mM or from about 0.1 mM to about 3 mM. These ranges can also apply to individual salts described herein.

In some embodiments, the diet beverage does not comprise potassium salts. In some embodiments, the diet beverage does not comprise KCl. In some embodiments, the diet beverage does not contain a K+ cation-containing salt in an amount from about 1 ppm to about 1,000 ppm.

Potassium citrate is typically included in carbonated soft drinks as a buffering agent and will not be present in the concentration range contemplated herein, i.e., from about 100 ppm to about 1,000 ppm.

The diet beverage or beverage product can optionally include additives, functional ingredients and combinations thereof, as described herein.

Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is at least one vitamin. Suitable vitamins include, vitamin A, vitamin D, vitamin E, vitamin K, vitamin B1, vitamin B2, vitamin B3, vitamin B5, vitamin B6, vitamin B7, vitamin B9, vitamin B12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

In certain embodiments, the functional ingredient is glucosamine, optionally further comprising chondroitin sulfate.

In certain embodiments, the functional ingredient is at least one mineral. In certain embodiments, the diet beverage further comprises at least one mineral. In certain embodiments, the combination of the at least one protein sweetener and the at least one mineral improves the taste profile with respect to sweetness linger and balance. Minerals, in accordance with the teachings of this invention, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In one embodiment, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In a particular embodiment, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in one embodiment, the minerals may be in their ionic form, having either a positive or negative charge. In another embodiment, the minerals may be in their molecular form. For example, sulfur and phosphorous often are found naturally as sulfates, sulfides, and phosphates.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside III, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in

U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen- like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (-OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and Δ5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the a and B isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof. In one embodiment, the composition further comprises one or more polyols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D-or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D-or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly (ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### III. Methods

Methods of enhancing the mouthfeel of a diet beverage and/or modulating one or more taste attributes of the diet beverage to make the diet beverage taste more like a sucrose-sweetened beverage are provided.

In one embodiment, a method of enhancing the mouthfeel of a beverage comprises (i) providing a diet beverage described hereinabove and (ii) adding at least one protein sweetener described herein to the diet beverage to provide a beverage with enhanced mouthfeel compared to the beverage in the absence of the at least one protein sweetener.

In another embodiment, a method of enhancing the mouthfeel of a diet beverage comprises (i) providing a diet beverage matrix and (ii) adding at least one protein sweetener described hereinabove to the beverage matrix to provide a diet beverage with enhanced mouthfeel.

In still another embodiment, a method of making a diet beverage taste more like a sucrose-sweetened beverage comprises (i) providing a diet beverage and (ii) adding at least one protein sweetener described herein in an amount effective to modulate one or more taste attributes of the diet beverage to make the diet beverage taste more like a sucrose-sweetened beverage compared to the beverage in the absence of the at least one protein sweetener. In yet another embodiment, a method of making a diet beverage taste more like a sucrose-sweetened beverage comprises (i) providing a diet beverage matrix and (ii) adding at least one protein sweetener described herein to the beverage to provide a beverage that tastes more like a sucrose-sweetened beverage, wherein the at least one protein sweetener is present in an amount effective to modulate one or more taste attributes of the diet beverage to make the diet beverage taste more like a sucrose-sweetened beverage compared to the diet beverage in the absence of the at least one protein sweetener.

Methods or preparing diet beverages with enhanced mouthfeel are also provided.

In one embodiment, a method of preparing a diet beverage comprises (i) providing a diet beverage described hereinabove and (ii) adding at least one protein sweetener described herein to the beverage.

In another embodiment, a method of preparing a diet beverage comprises (i) providing a diet beverage matrix and (ii) adding at least one protein sweetener described herein to the beverage matrix.

In certain embodiments of the foregoing methods, the diet beverage further comprises at least one non-sucrose sweetener. The at least one non-sucrose sweetener and at least one protein sweetener can be added together, i.e. in the form of a composition, or separately.

### EXAMPLES

### Example 1: Sensorial Effect of Protein Sweetener in Juices

### Sample Preparation

Samples were prepared using Simply Orange Juice (100% Pulp free), treated water and Thaumatin (available as Talin® from Naturex) according to the follow protocol:

1. Simply Orange Juice (100% Pulp free) (84 g) and treated water (16 g) were combined.
2. The beverage ingredients were mixed for 10 minutes using a high shear mixer (300 rpm).
3. Thaumatin was added according to Table 1.
4. The beverage samples were mixed for 15 minutes using a high shear mixer (400 rpm).
5. The beverage samples were stored in a glass bottle and cap. Beverages were stored in a refrigerator for between 3 to 7 days prior to sensory evaluation.
Four beverage samples were prepared. The composition and theoretical Brix for the samples is provided in Table 1. The batch size for each sample was 1500mL.

TABLE 1
Compositions and Theoretical Brix

| | | Thaumatin | Theoretical |
|---|---|---|---|
| Sample | Composition | (ppm) | Brix |
| 1 | Simply Orange Juice (100% Pulp free) | 0 | 12.51 |
| (Control) | | | |
| 2 | Simply Orange Juice (100% Pulp free), | 2 | 10.51 |
| | water and 2 ppm Thaumatin | | |
| 3 | Simply Orange Juice (100% Pulp free), | 4 | 10.51 |
| | water and 4 ppm Thaumatin | | |
| 4 | Simply Orange Juice (100% Pulp free), | 6 | 10.51 |
| | water and 6 ppm Thaumatin | | |

### Taste Evaluation

Taste tests were carried out with a minimum of 6 panelists. Bottles or vials were removed from the refrigerator. Samples were poured in the tasting cups and were tasted by panelists while analyzing the samples using tasting sheets. Panelists were given mineral water to rinse their mouth before tasting and between tasting different samples. Unsalted crackers were also given to panelists to eat followed by rinsing their mouth with mineral water before tasting the next sample.

### Results

TABLE 2
Examples of Mouthfeel Enhancement with Thaumatin

| | Sample 1 | Sample 2 | Sample 3 | Sample 4 |
|---|---|---|---|---|
| Lingering | Least | | Slightly bitter | Slightly bitter |
| | | | lingering | lingering |
| Mouthfeel | | Best | Second best | |
| Sweetness | Second Best | Last | Best | Second Best |
| Quality/ | (Tied) | | | (Tied) |
| Intensity | | | | |

Panelists did not note any discernible difference among the samples with respect to acidity, off notes and flavor changes.

### Example 2: Sensorial Effect of Protein Sweeteners in Reduced Sugar Orange Juice

### Sample Preparation

Samples were prepared using 50 calorie/serving Simply® Light Orange Juice (6° Bx) and Thaumatin (available as Talin® from Naturex) according to the follow protocol:

1. Thaumatin according to Table 3 was added to Simply® Light Orange Juice and mixed for 10 minutes using a high shear mixer (300 rpm).
2. The beverages were transferred to a glass bottle and cap and stored in the refrigerator.

TABLE 3
Compositions of Reduced Sugar Orange Juice Sample

| Sample | Thaumatin |
|---|---|
| A | 0 ppm |
| (Control) | |
| B | 4 ppm |
| C | 6 ppm |

### Taste Evaluation

Taste tests were carried out with a minimum of 6 panelists. Bottles or vials were removed from the refrigerator. Samples were poured in the tasting cups and were tasted by panelists while analyzing the samples using tasting sheets. Panelists were given mineral water to rinse their mouth before tasting and between tasting different samples. Unsalted crackers were also given to panelists to eat followed by rinsing their mouth with mineral water before tasting the next sample.

### Results

Panelists noted that Samples B and C delivered sweeter, fuller orange taste with more mouthfeel than Sample A. Panelists did not taste off notes in Samples B and C.

### Example 3: Lemon-Lime Beverage

Lemon-lime sparking beverage samples were prepared with 5% sugar, 150 ppm Reb M and 5 ppm thaumatin. Citric acid and malic acid were added in the following amounts (wt %):

TABLE 4

| Acid | Sample 1 | Sample 2 |
|---|---|---|
| Citric acid | 0.12% | 0.12% |
| Malic acid | | 0.006% |

1. A diet beverage comprising at least one protein sweetener, wherein the at least one protein sweetener modulates one or more taste attributes of the diet beverage to make the beverage taste more like a sucrose-sweetened beverage and/or to enhance mouthfeel of the diet beverage; wherein the at least one protein sweetener is selected from the group consisting of thaumatin, modified thaumatin, brazzein, modified brazzein, and a combination thereof.

2. (canceled)

3. (canceled)

4. (canceled)

5. The diet beverage of claim 1, further comprising a high potency sweetener.

6. The diet beverage of claim 5, wherein the high potency sweetener is selected from the group consisting of steviol glycosides, steviol glycoside mixtures, mogrosides, mogroside mixtures, synthetic sweeteners, and combinations thereof.

7. The diet beverage of claim 1, wherein the diet beverage further comprises sucrose.

8. The diet beverage of claim 7, wherein the Brix of the beverage is from about 4° Bx to about 12° Bx.

9. The diet beverage of claim 7, further comprising a high potency sweetener selected from the group consisting of steviol glycosides, steviol glycoside mixtures, mogrosides, mogroside mixtures, synthetic sweeteners, and combinations thereof.

10. The diet beverage of claim 9, wherein the concentration of steviol glycoside mixture is from about 50 ppm to about 600 ppm.

11. The diet beverage of claim 1, wherein the beverage is selected from a reduced-calorie beverage and a zero-calorie beverage.

12. The diet beverage of claim 1, wherein the beverage is selected from the group consisting of frozen carbonated beverages, sparkling beverages, cola, fruit-flavored sparkling beverages, ginger-ale, soft drinks, root beer, fruit juice, fruit-flavored juice, juice beverage, nectars, vegetable juice, vegetable-flavored juice, sports drinks, energy drinks, enhanced water drinks, water with vitamins, water with natural or synthetic flavorants), coconut water, tea type drinks, coffee, cocoa drink, beverage containing milk components, beverages containing cereal extracts, smoothies, alcoholic beverages, and plant protein-containing beverages.

13. The diet beverage of claim 12, wherein the beverage is a diet juice beverage.

14. The diet beverage of claim 13, wherein the diet juice beverage comprises sucrose-sweetened orange juice and thaumatin.

15. The diet beverage of claim 14, wherein the sucrose-sweetened orange juice is from 8° Bx to about 10.5° Bx.

16. The diet beverage of claim 13, wherein the diet juice beverage comprises a reduced-sugar orange juice and thaumatin.

17. The diet beverage of claim 16, wherein the reduced-sugar orange juice comprises at least one steviol glycoside mixture sweetener and is from about 4° Bx to about 8° Bx.

18. The diet beverage of claim 12, wherein the diet beverage is a sparkling beverage, and the protein sweetener is brazzein.

19. The diet beverage of claim 18, wherein the sparkling beverage is from about 3° Bx to about 8° Bx.

20. The diet beverage of claim 18, further comprising a steviol glycoside mixture sweetener.

21. (canceled)

22. (canceled)

23. (canceled)

24. (canceled)

25. (canceled)

26. The diet beverage of claim 6, wherein the synthetic sweetener is selected from the group consisting of sucralose, potassium acesulfame, aspartame, alitame, saccharin, cyclamate, neotame, advantame, and combinations thereof.

27. The diet beverage of claim 26, wherein the synthetic sweetener comprises sucralose and potassium acesulfame.

28. (canceled)

29. The diet beverage of claim 1, wherein the diet beverage further comprises at least one salt having a cation selected from Ca²⁺ and Mg²⁺ and an anion selected from lactate, citrate, gluconate, anhydrous and hydrate forms thereof, and combinations thereof.

30. (canceled)

31. (canceled)
